(19) United States
(12) Patent Application Publication
(10) Pub. No.: US 2022/0066105 A1
(43) Pub. Date: Mar. 3, 2022

(54) FIBRE OPTIC CONNECTOR INSERTION AND REMOVAL TOOL

(71) Applicant: EZCONN CORPORATION, New Taipei City (TW)

(72) Inventor: Szu ming Chen, New Taipei City (TW)

(21) Appl. No.: 17/366,033

(22) Filed: Jul. 2, 2021

(30) Foreign Application Priority Data
Aug. 28, 2020 (TW) 109211254

(51) Int. Cl. G02B 6/38

(52) U.S. Cl. CPC G02B 6/3898

(57) ABSTRACT

A fibre optic connector insertion and removal tool, comprising a portable light, light conduit, first gripping apparatus, and second gripping apparatus is provided. The first gripping apparatus has a U-shaped fork comprising first and second arms and at least a gripping element. Tip portions of the first and second arms and the at least a gripping element form a vice-like grip for insertion of a fibre optic connector having a trigger mechanism and at least a connector. When the first and second arms move toward the trigger mechanism, a vice-like gripping force is formed between tip portions of the first and second arms and at least a gripping element, squeezing the trigger mechanism for removal of the fibre optic connector. The light conduit transmits or guides light to the tip portions of the first and second arm. The first gripping apparatus is removable and replaceable with the second gripping apparatus.

### RELATED APPLICATIONS

The application claims the benefit of priority to Taiwan application no. 109211254, filed on Aug. 28, 2020, of which is incorporated herein by reference in its entirety.

### TECHNICAL FIELD

Example embodiments relate generally to the field of optical communications and, more particularly, to fibre optic connector installation tools.

### BACKGROUND

Driven by the ever-growing computing demands of cloud users, generation of massive amounts of data by edge computing devices such as AI-enabled IoT devices, and roll-out of 5G networks, the architectures of hyperscale, colocation and on-premise data centers have rapidly evolved and new data centers closer to end-users or devices have been built as the demand for services that rely on edge data centers increase.

For data centers, whether it's new builds or network upgrades, proper cabling infrastructure is required for successful application delivery within the data centers. The cabling infrastructure must be reliable, easy to install, modular and flexible, to accommodate changes, and scalable, to support data center growth. In general, the cabling infrastructure connects the end and intermediate points of traffic patterns within the data centers to and from routers, interconnection switches, access switches, servers, SAN switches and storage. Of the types of cabling employed in data centers, fiber optic cables support high data rates for high-speed network interfaces and protocol standards.

Generally, for installation of fiber optic cables, pre-connectorized fiber optic cables may be utilized for snap fit connections. The connectors mechanically couple and align core fibers and allow for the efficient transfer of light. Generally, the connectors comprise of cables, ferrules, a connector body, and a connector device. Of the optic fiber connectors, such as Lucent connectors (LC), square connectors (SC) and MPO connectors, LC duplex and LC uniboot fiber optic connectors are fiber optic connectors with a pair of multimode fiber (MMF) or singlemode fiber (SMF), that transmit data in two opposite directions, one in each optical fiber. For example, a transmit signal (Tx) port and receiver (Rx) port of an LC duplex fiber optic connector should always be connected to a receiver (Rx) port and a transmit signal (Tx) port of a corresponding LC duplex fiber optic connector, respectively.

LC duplex and LC uniboot fiber optic adapters join and align connectors of two LC duplex and LC uniboot fiber optic cables together, respectively. An important feature for optical fiber connection is the precise alignment of each optical fiber core. The alignment is influenced by a ferrule within each connector and an alignment port within each adapter, bringing together the ferrules of the two connectors being mated within the adapter's port and at its approximate midpoint.

With new data centers being built and existing data centers being upgraded the problem of poor fiber connection alignment and/or crossing of fiber optic cables during installation have increased. Often, there are multiple adapters and optic fiber segments connected in a data center, with denser network configurations, changing not just once, but, several times during deployment. A wrong connection, results in non-precise alignment of the optical fiber cores, signal degradation, damaged equipment or devices, or signals not being transmitted. Changing of the multiple adapters and optic fiber segments, wherein any manual adjustment to connectors is required, increases the risk of non-precise alignment of the optical fiber cores of the adapters and optic fiber segments and damage to neighboring adapters and optic fiber segments. Additionally, changing of the multiple adapters and optic fiber segments, require installers to carefully inspect adapters, often, in less than clearly visible conditions, to assure desired polarity connection, which further increases installation time and/or additional tools for clear visibility. If additional tools are required by installers, often, the tools may only be used with a specific type of fibre optic connector, thus, requiring the installer to carry more than one type of tool for each specific type of fibre optic connector.

### SUMMARY

Fibre optic connector insertion and removal tools for installing fibre optic connectors are provided.

In an embodiment, a fibre optic connector insertion and removal tool, configured for installing fibre optic connectors, comprising a first gripping apparatus configured to grip fibre optic connectors is provided. The first gripping apparatus has a U-shaped fork comprising a first closed end, a first arm, a second arm, and at least a gripping element. The first arm is connected to one end of the first closed end and the second arm is connected to an other end of the first closed end, opposite the first arm. The at least a gripping element is disposed near to a tip or tips of the first or second arm or both, opposite the first closed end. The tips of the first and second arms and the at least a gripping element form a vice-like grip, whereby the first and second arms are configured to hold a fibre optic connector therein for insertion into adapters, couplers, modules and ports of fibre optic systems. The fibre optic connector has a trigger mechanism and at least a connector. When the first and second arms are moved toward the trigger mechanism, a vice-like gripping force is formed between the tip portions of the first and second arms and at least a gripping element, squeezing the trigger mechanism for removal of the fibre optic connector from the adapters, couplers, modules and ports of fibre optic systems.

In some embodiments, the fibre optic connector insertion and removal tool further comprises a portable light and a light conduit. The portable light is configured to emit light and has a handle and a head, wherein the head comprises a pill end and an emissions end, and the pill end is connected to the handle. The light conduit is configured to transmit or guide light and has a distal end and a proximal end, wherein the distal end is attached to the emissions end. The first closed end is attached to the proximal end, and the light conduit transmits or guides light to the tip portions of the first and second arm.

In an embodiment, a fibre optic connector insertion and removal tool, comprising a portable light, a light conduit, and a first gripping apparatus is provided. The portable light is configured to emit light and has a handle and a head. The head comprises a pill end and an emissions end, and the pill end is connected to the handle. The light conduit is configured to transmit or guide light and has a distal end and a proximal end, wherein the distal end is attached to the emissions end. The first gripping apparatus is configured to grip fibre optic connectors and has a U-shaped fork comprising a first closed end, a first arm, a second arm, and at least a gripping element. The first arm is connected to one end of the first dosed end and the second arm is connected to an other end of the first closed end, opposite the first arm. The at least a gripping element is disposed near to a tip or tips of the first or second arm or both, opposite the first closed end. The first closed end is attached to the proximal end. The light conduit transmits or guides light to the tip portions of the first and second arm. Tip portions of the first and second arms and the at least a gripping element form a vice-like grip, whereby the first and second arms are configured to hold a fibre optic connector therein for insertion into adapters, couplers, modules and ports of fibre optic systems. The fibre optic connector has a trigger mechanism and at least a connector. When the first and second arms are moved toward the trigger mechanism, a vice-like gripping force is formed between the tip portions of the first and second arms and at least a gripping element, squeezing the trigger mechanism for removal of the fibre optic connector from the adapters, couplers, modules and ports of fibre optic systems.

In some embodiments, the portable light further comprises a light emitting diode (LED) unit disposed in the pill end, configured to switch the portable light on and off. In certain embodiments, a material of the light conduit comprises optical grade Polymethyl Methacrylate (PMMA).

In some embodiments, the first gripping apparatus further comprises a first stem protruding from the first closed end, the light conduit further comprises a receiving hole at the proximal end, and the fibre optic connector insertion and removal tool further comprises a second gripping apparatus having a second stem protruding from a second closed end. The second gripping apparatus is different from the first gripping apparatus. The first stem is inserted into the receiving hole for attachment of the first gripping apparatus to the light conduit. The first gripping apparatus is removable from the receiving hole and replaceable with the second gripping apparatus.

In some embodiments, the at least a gripping element comprises a stop ledge disposed near to a tip of the first arm on an inner surface thereof. When the first and second arms are moved toward the trigger mechanism, an inner surface of the tip of the first arm abuts a central portion of the trigger mechanism and the stop ledge abuts an end of the trigger mechanism, together with the second arm, form the vice-like gripping force squeezing the trigger mechanism for removal of the fibre optic connector from the adapters, couplers, modules and ports of fibre optic systems.

In some embodiments, the at least a gripping element comprises a grip ledge disposed near to a center of the first arm on an inner surface thereof, and the fibre optic connector further has a boot on an end thereof. When the first and second arms are moved toward the trigger mechanism, an inner surface of the tip of the first arm abuts a central portion of the trigger mechanism and the grip ledge abuts the boot, together with the second arm, form the vice-like gripping force squeezing the trigger mechanism for removal of the fibre optic connector from the adapters, couplers, modules and ports of fibre optic systems.

In some embodiments, the at least a gripping element comprises a stop groove disposed near to a tip of the second arm on an inner surface thereof, and the fibre optic connector further has an outer protrusion near to an end thereof. When the first and second arms are moved toward the trigger mechanism, an inner surface of the tip of the first arm abuts a central portion of the trigger mechanism and the stop groove of the second arm abuts the outer protrusion, forming the vice-like gripping force squeezing the trigger mechanism for removal of the fibre optic connector from the adapters, couplers, modules and ports of fibre optic systems.

In some embodiments, the at least a gripping element comprises a plurality of ridges disposed surrounding a tip of the first arm on a side and inner surface thereof. When the first and second arms are moved toward the trigger mechanism, the plurality of ridges disposed on the inner surface of the tip of the first arm abuts a central portion of the trigger mechanism, together with the second arm, form the vice-like gripping force squeezing the trigger mechanism for removal of the fibre optic connector from the adapters, couplers, modules and ports of fibre optic systems.

In some embodiments, the fibre optic connector comprises an LC fibre optic connector or an LC uniboot fibre optic connector. In some embodiments, the fibre optic connector comprises a duplex fibre optic connector.

The tips of the first and second arms of the gripping apparatus and at least a gripping element of the embodiments form a vice-like grip on fibre optic connectors to efficiently and conveniently hold the fibre optic connectors for precise installation. Additionally, the vice-like gripping force formed between the tip portions of the first and second arms and at least a gripping element when the gripping apparatus moves toward the fibre optic connectors, squeezes the trigger mechanism for efficient and convenient unhinging and removal of the fibre optic connectors. The ease of use, removability and replaceability of the first gripping apparatus with the second gripping apparatus via the first stem being inserted into the receiving hole for attachment, allows technicians to quickly and efficiently change the gripping apparatus to more efficiently hold, grip, and manipulate different types of fibre optic connectors. The portable light and light conduit transmits or guides light to the tip portions of the first and second arm, allowing installers to efficiently, conveniently and carefully inspect adapters in a dear and visible condition.

### BRIEF DESCRIPTION OF THE DRAWINGS

Unless specified otherwise, the accompanying drawings illustrate aspects of the innovative subject matter described herein. Referring to the drawings, wherein like reference numerals indicate similar parts throughout the several views, several examples of fibre optic connector insertion and removal tool' incorporating aspects of the presently disclosed principles are illustrated by way of example, and not by way of limitation.

FIG. 1A is a first perspective view of a fibre optic connector, according to an example embodiment.

FIG. 1B is a second perspective view of the fibre optic connector of FIG. 1A, according to an example embodiment.

FIG. 1C is a third perspective view of the fibre optic connector of FIG. 1A, according to an example embodiment.

FIG. 2A is a first perspective view of another fibre optic connector, according to an example embodiment.

FIG. 2B is a second perspective view of the another fibre optic connector of FIG. 2A, according to an example embodiment.

FIG. 2C is a third perspective view of the another fibre optic connector of FIG. 2A, according to an example embodiment.

FIG. 3 is a perspective view of a fibre optic connector insertion and removal tool, according to an example embodiment.

FIG. 4 is a schematic exploded view of the fibre optic connector insertion and removal tool of FIG. 3, according to an example embodiment.

FIG. 5 is a schematic cross-sectional view of a first gripping apparatus of the fibre optic connector insertion and removal tool of FIG. 4, according to an example embodiment.

FIG. 6 is a schematic cross-sectional partial view of the fibre optic connector insertion and removal tool of FIG. 3, according to an example embodiment.

FIG. 7 is a perspective view of the fibre optic connector insertion and removal tool of FIG. 3 having a vice-like gripping force, squeezing a trigger mechanism of the fibre optic connector of FIG. 1A, according to an example embodiment.

FIG. 8 is a schematic enlarged view of the first gripping apparatus and fibre optic connector of FIG. 7, according to an example embodiment.

FIG. 9 is a schematic exploded view of another fibre optic connector insertion and removal tool, according to an example embodiment.

FIG. 10 is a schematic cross-sectional view of a second gripping apparatus of the fibre optic connector insertion and removal tool of FIG. 9, according to an example embodiment.

FIG. 11 is a first perspective view of the fibre optic connector insertion and removal tool of FIG. 9 having a vice-like gripping force, squeezing a trigger mechanism of the fibre optic connector of FIG. 2A, according to an example embodiment.

FIG. 12 is a second perspective view of the fibre optic connector insertion and removal tool of FIG. 9 having a vice-like gripping force, squeezing a trigger mechanism of the fibre optic connector of FIG. 2A, according to an example embodiment.

FIG. 13 is a schematic enlarged view of the second gripping apparatus and fibre optic connector of FIG. 12, according to an example embodiment.

### DETAILED DESCRIPTION

The following describes various principles related to optical communications by way of reference to specific examples of fibre optic connector installation tools, including arrangements and examples of fibre optic connector insertion and removal tools embodying innovative concepts. More particularly, but not exclusively, such innovative principles are described in relation to selected examples of portable lights, light conduits, U-shaped forks and gripping elements and well-known functions or constructions are be described in detail for purposes of succinctness and clarity. Nonetheless, one or more of the disclosed principles can be incorporated in various other embodiments of portable lights, light conduits, U-shaped forks and gripping element to achieve any of a variety of desired outcomes, characteristics, and/or performance criteria.

Thus, portable lights, light conduits, U-shaped forks and gripping elements having attributes that are different from those specific examples discussed herein can embody one or more of the innovative principles, and can be used in applications not described herein in detail. Accordingly, embodiments of portable lights, light conduits, U-shaped forks and gripping elements not described herein in detail also fall within the scope of this disclosure, as will be appreciated by those having ordinary skill in the relevant art following a review of this disclosure.

Example embodiments as disclosed herein are directed to fibre optic pulling grip assemblies. In an embodiment, A fibre optic connector insertion and removal tool, comprising a portable light, light conduit, first gripping apparatus, and second gripping apparatus is provided. The first gripping apparatus has a U-shaped fork comprising first and second arms and at least a gripping element. Tip portions of the first and second arms and the at least a gripping element form a vice-like grip for insertion of a fibre optic connector having a trigger mechanism and at least a connector. When the first and second arms move toward the trigger mechanism, a vice-like gripping force is formed between tip portions of the first and second arms and at least a gripping element, squeezing the trigger mechanism for removal of the fibre optic connector. The light conduit transmits or guides light to the tip portions of the first and second arm. The first gripping apparatus is removable and replaceable with the second gripping apparatus.

Generally, the fibre optic connector of the embodiments may be used by commercial businesses, governments, data centers, and FTTH and FTTB networks of telecom companies, as an example, and is not limited to any particular type of fibre optic connector. As long as the fibre optic connector has a trigger mechanism and at least a connector.

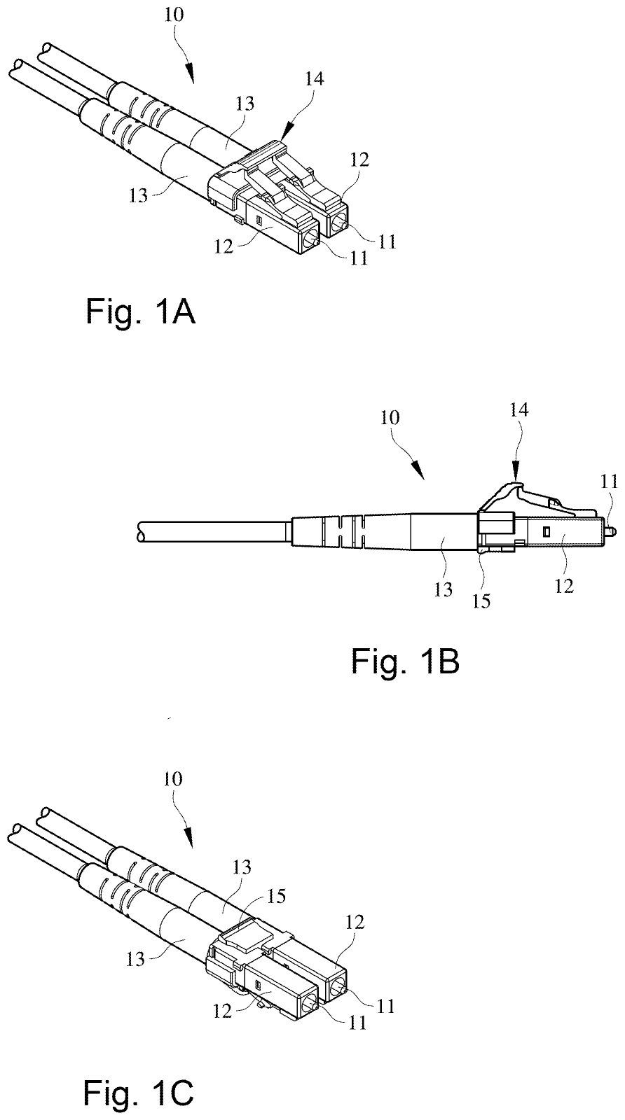

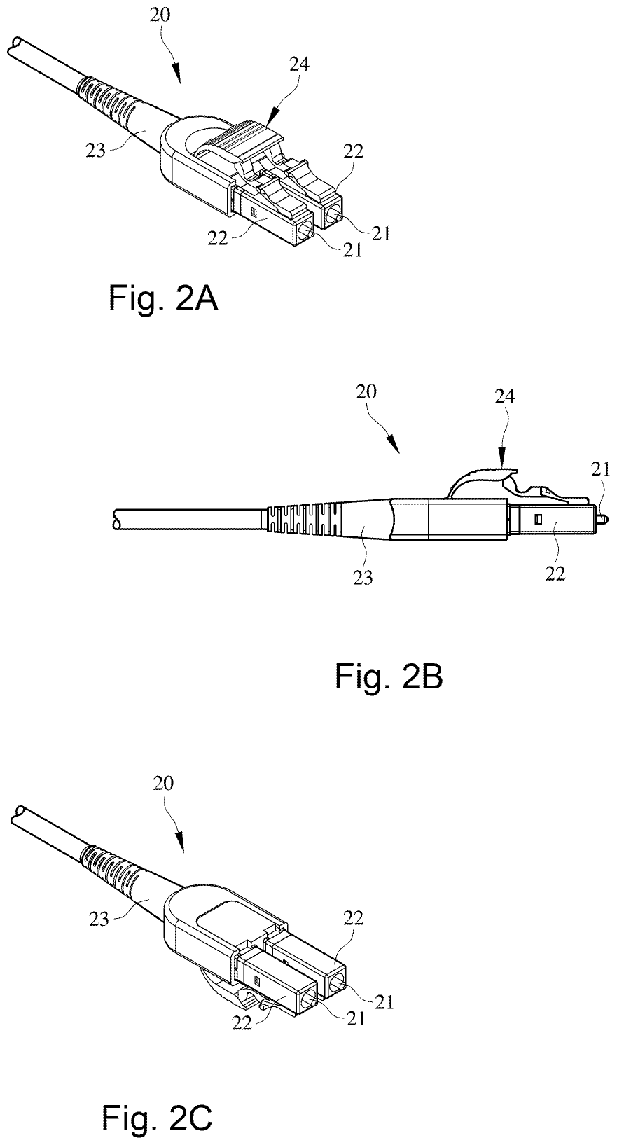

In some embodiments, the fibre optic connector comprises an LC fibre optic connector or an LC uniboot fibre optic connector. In some embodiments, the fibre optic connector comprises a duplex fibre optic connector. FIGS. 1A to 1B are perspective views of a fibre optic connector, according to an example embodiment. FIGS. 2A to 2C are perspective views of another fibre optic connector, according to an example embodiment. Generally, the fibre optic connector 10, 20 comprises at least a connector 12, 22 having a fibre optic ferrule 11, 22, a trigger mechanism 14, 24, and a boot 13, 23. In some embodiments, the fibre optic connector further comprises an outer protrusion 15. Those of ordinary skill in the relevant art may readily appreciate that the fibre optic connector 10, 20 may comprise additional elements and the embodiments are not limited.

The attached elements of the fibre optic connector insertion and removal tool of the embodiments may be separately and/or integrally formed and made of any suitable material known to those having ordinary skill in the relevant art. As long as the gripping apparatus' are removable and replaceable with different gripping apparatus'.

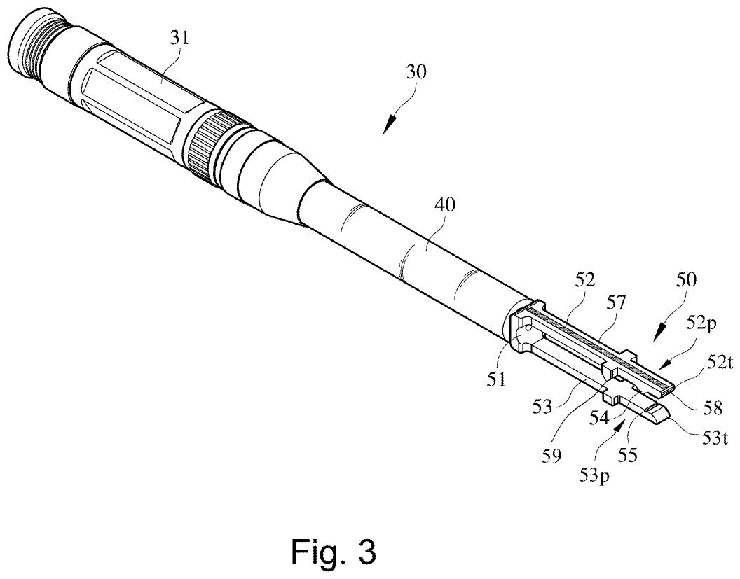

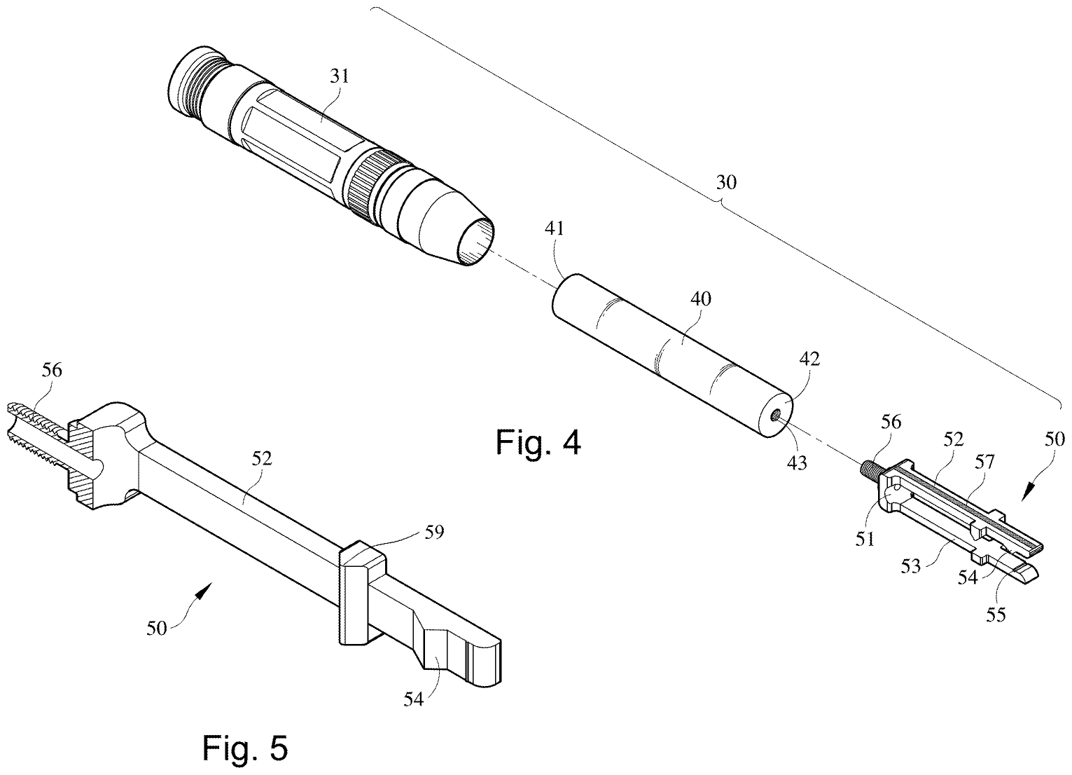

FIGS. 3 to 5 are a perspective, schematic exploded, and schematic cross-sectional view of a fibre optic connector insertion and removal tool 30, according to an example embodiment. Referring to FIGS. 3 to 5, in an embodiment, a fibre optic connector insertion and removal tool 30, configured for installing fibre optic connectors, comprising a first gripping apparatus 50 configured to grip fibre optic connectors is provided. The first gripping apparatus 50 has a U-shaped fork comprising a first closed end 51, a first arm 52, a second arm 53, and at least a gripping element. The first arm 52 is connected to one end of the first closed end 51 and the second arm 53 is connected to an other end of the first closed end 51, opposite the first arm 52. The at least a gripping element is disposed near to a tip or tips 52t, 53t of the first or second arm 52, 53 or both, opposite the first closed end 51. The tips 52t, 53t of the first and second arms 52, 53 and the at least a gripping element form a vice-like grip, whereby the first and second arms 52, 53 are configured to hold a fibre optic connector 10 therein for insertion into adapters, couplers, modules and ports of fibre optic systems. The fibre optic connector 10 has a trigger mechanism 14 and at least a connector 12. When the first and second arms 52, 53 are moved toward the trigger mechanism 14, a vice-like gripping force is formed between the tip portions 52p, 53p of the first and second arms 52, 53 and at least a gripping element, squeezing the trigger mechanism 14 for removal of the fibre optic connector 10 from the adapters, couplers, modules and ports of fibre optic systems.

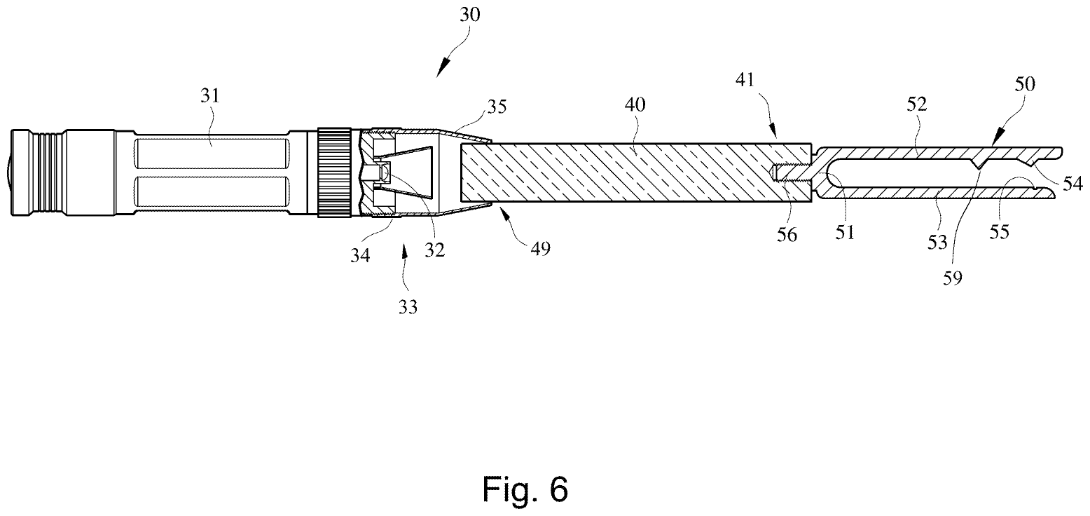

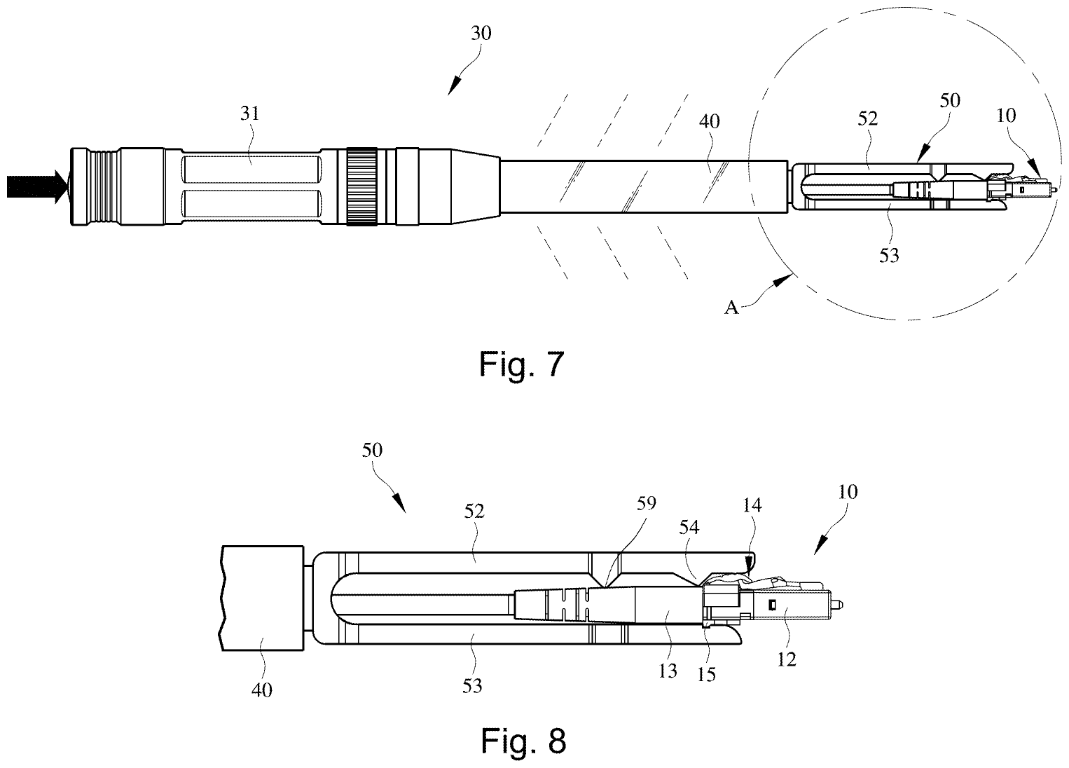

In some embodiments, the fibre optic connector insertion and removal tool 30 further comprises a portable light 31 and a light conduit 40. FIG. 6 is a schematic cross-sectional partial view of the fibre optic connector insertion and removal tool of FIG. 3, according to an example embodiment. FIGS. 7 and 8 is a perspective and schematic enlarged view of the fibre optic connector insertion and removal tool 30 of FIG. 3 having a vice-like gripping force, squeezing a trigger mechanism 14 of the fibre optic connector 10 of FIG. 1A, according to an example embodiment. The portable light 31 is configured to emit light and has a handle 31 and a head 33, wherein the head 33 comprises a pill end 34 and an emissions end 35, and the pill end 34 is connected to the handle 31. The light conduit 40 is configured to transmit or guide light and has a distal end 49 and a proximal end 41, wherein the distal end 49 is attached to the emissions end 35. The first closed end 51 is attached to the proximal end 41, and the light conduit 40 transmits or guides light to the tip portions 52p, 53p of the first and second arms 52, 53.

In an embodiment, a fibre optic connector insertion and removal tool 30, 70 comprising a portable light 31, a light conduit 40, and a first and second gripping apparatus 50, 70 is provided. The portable light 31 is configured to emit light and has a handle 31 and a head 33. The head 33 comprises a pill end 34 and an emissions end 35, and the pill end 34 is connected to the handle 31. The light conduit 40 is configured to transmit or guide light and has a distal end 49 and a proximal end 41, wherein the distal end 49 is attached to the emissions end 35. The first gripping apparatus 50 is configured to grip fibre optic connectors and has a U-shaped fork comprising a first closed end 51, a first arm 52, a second arm 53, and at least a gripping element. The first arm 52 is connected to one end of the first closed end 51 and the second arm 53 is connected to an other end of the first closed end 51, opposite the first arm 52. The at least a gripping element is disposed near to a tip or tips 52t, 53t of the first or second arm 52, 53 or both, opposite the first closed end 51. The first closed end 51 is attached to the proximal end 41.

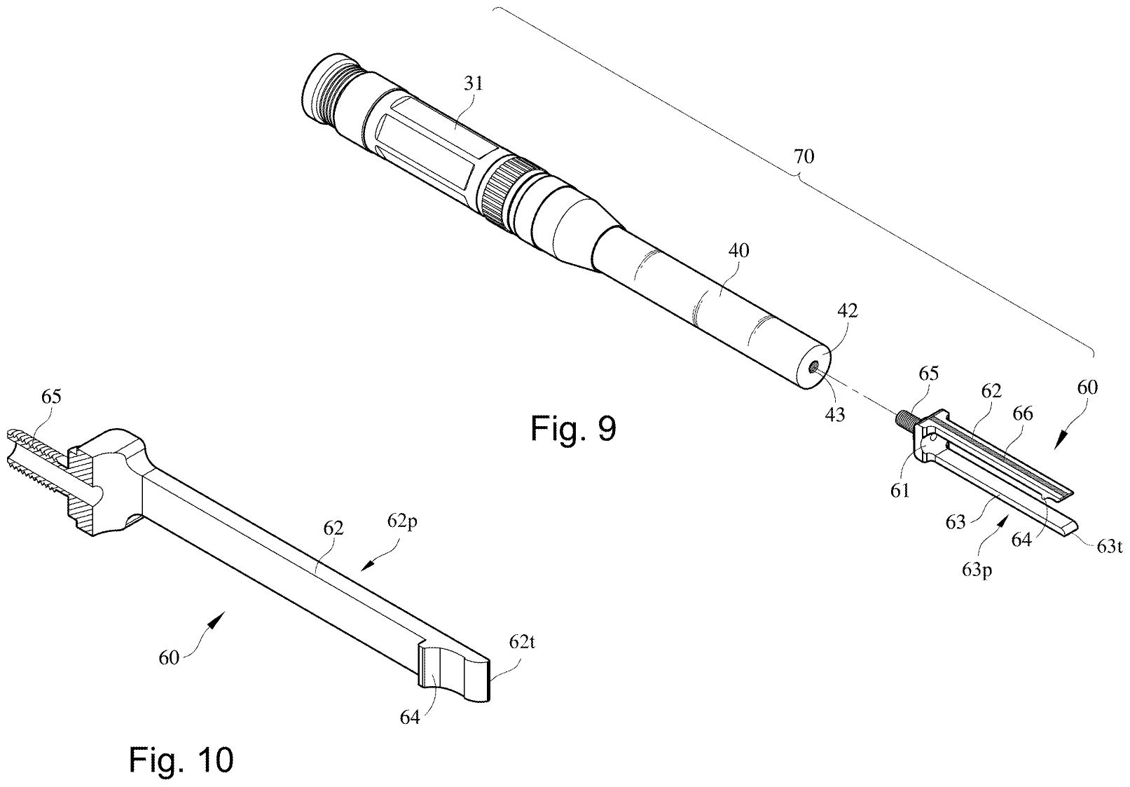

FIGS. 9 and 10 are a schematic exploded and a schematic cross-sectional view of another fibre optic connector insertion and removal tool 70, according to an example embodiment. Referring to FIGS. 9 and 10, in an embodiment, a fibre optic connector insertion and removal tool 70, configured for installing fibre optic connectors, comprising a second gripping apparatus 60 configured to grip fibre optic connectors is provided. The second gripping apparatus 60 has a U-shaped fork comprising a first closed end 61, a first arm 62, a second arm 63, and at least a gripping element. The first arm 62 is connected to one end of the first closed end 61 and the second arm 63 is connected to an other end of the first closed end 61, opposite the first arm 62. The at least a gripping element is disposed near to a tip or tips 62t, 63t of the first or second arm 62, 63 or both, opposite the second closed end 61. The second closed end 61 is attached to the proximal end 41. The tips 62t, 63t of the first and second arms 62, 63 and the at least a gripping element form a vice-like grip, whereby the first and second arms 62, 63 are configured to hold a fibre optic connector 20 therein for insertion into adapters, couplers, modules and ports of fibre optic systems. The fibre optic connector 20 has a trigger mechanism 24 and at least a connector 22. When the first and second arms 62, 63 are moved toward the trigger mechanism 24, a vice-like gripping force is formed between the tip portions 62p, 63p of the first and second arms 62, 63 and at least a gripping element, squeezing the trigger mechanism 24 for removal of the fibre optic connector 20 from the adapters, couplers, modules and ports of fibre optic systems.

The light conduit 40 transmits or guides light to the tip portions 52p, 53p, 62p, 63p of the first and second arms 52, 53, 62, 63. Tip portions 52p, 53p, 62p, 63p of the first and second arms 52, 53, 62, 63 and the at least a gripping element form a vice-like grip, whereby the first and second arms 52, 53, 62, 63 are configured to hold a fibre optic connector 10, 20 therein for insertion into adapters, couplers, modules and ports of fibre optic systems. The fibre optic connector 10, 20 has a trigger mechanism 14, 24 and at least a connector 12, 22. When the first and second arms 52, 53, 62, 63 are moved toward the trigger mechanism 14, 24, a vice-like gripping force is formed between the tip portions 52p, 53p, 62p, 63p of the first and second arms 52, 53, 62, 63 and at least a gripping element, squeezing the trigger mechanism 14, 24 for removal of the fibre optic connector 10, 20 from the adapters, couplers, modules and ports of fibre optic systems.

In certain embodiments, the shape of the emissions end 35 of the head 33 is conical shaped for effectively guiding light to the light conduit 40 for effective transmission or guiding of the light to the tip portions 52p, 53p, 62p, 63p of the first and second arms 52, 53. Additionally, the conical shape of the emissions end 35 is configured for efficient attachment of the distal end 49 of the light conduit 40 to the emissions end 35 of the head 33.

In some embodiments, the portable light 31 further comprises a light emitting diode (LED) unit 32 disposed in the pill end 34, configured to switch the portable light 31 on and off. In certain embodiments, a material of the light conduit 40 comprises optical grade Polymethyl Methacrylate (PMMA).

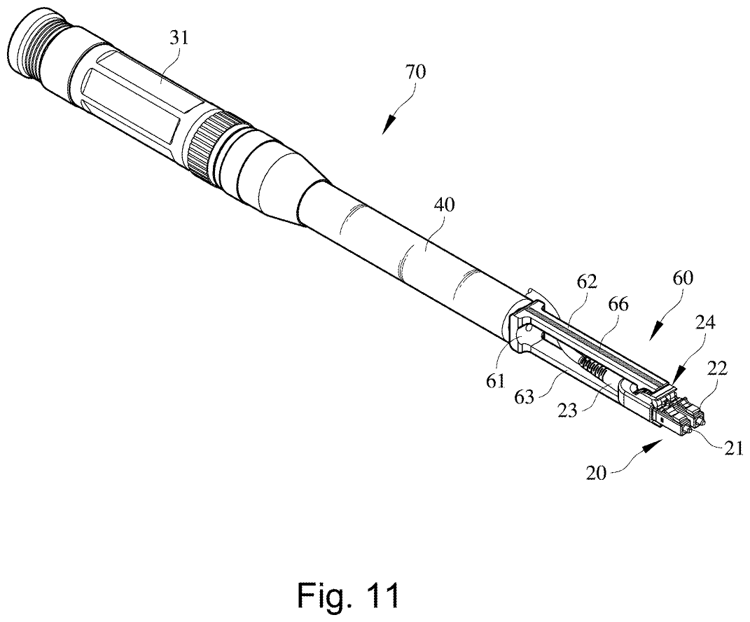

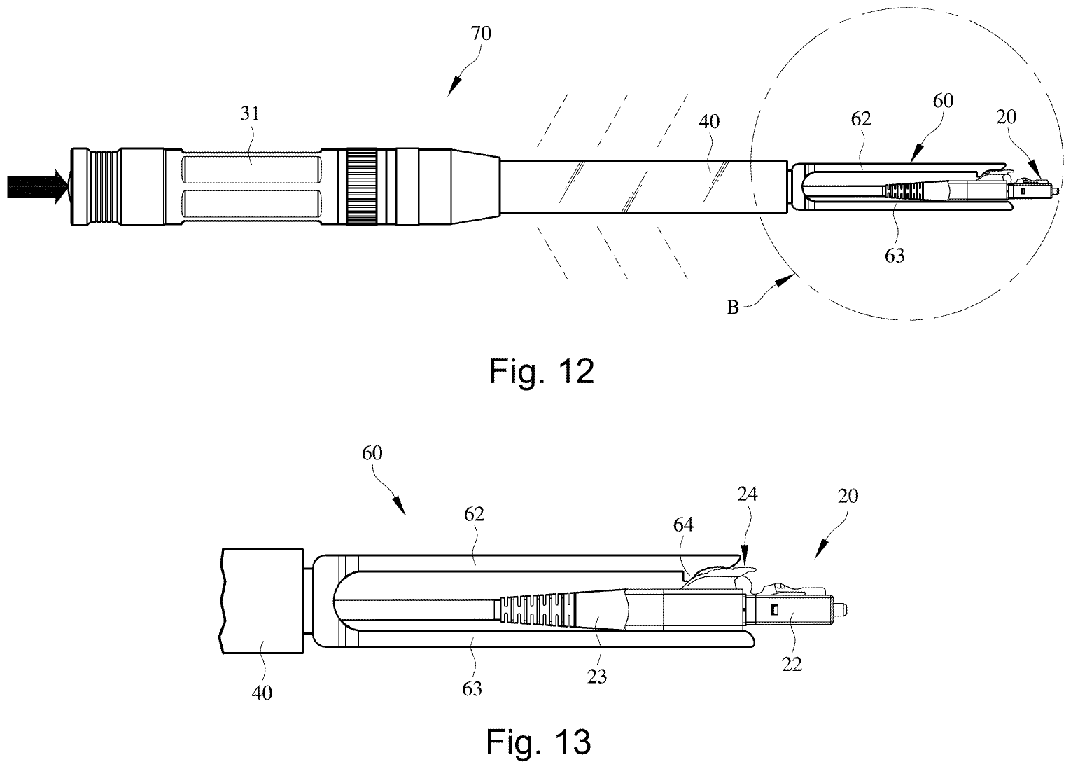

In some embodiments, the first and second gripping apparatus' 50, 70 further comprise a first and second stem 56, 65 protruding from the first and closed end 51, 61, the light conduit 40 further comprises a receiving hole 43 at the proximal end 41, and the fibre optic connector insertion and removal tool 30, 70 further comprises a second gripping apparatus 60. FIGS. 11 to 13 are perspective views and a schematic enlarged view of the fibre optic connector insertion and removal tool 70 of FIG. 9 having a vice-like gripping force, squeezing a trigger mechanism 24 of the fibre optic connector 20 of FIG. 2A, according to an example embodiment. Referring to FIGS. 9 to 13, and referring to FIGS. 2A to 4 and FIGS. 6 and 7, the first stem 56 is inserted into the receiving hole 43 for attachment of the first gripping apparatus 50 to the light conduit 40. The first gripping apparatus 50 is removable from the receiving hole 43 and replaceable with the second gripping apparatus 60 via a second stem 65.

In some embodiments, the first and the second stems 56, 65 contain threads and the receiving hole 43 is configured for screwing of the first and the second stems 56, 65 therein; however, those of ordinary skill in the relevant art may readily appreciate, that other designs may be implemented for attachment of the first and second closed ends 51, 61 to the proximal end 41 or insertion of the first and the second stems 56, 65 into the receiving hole 43, and the embodiments are not limited.

In some embodiments, the at least a gripping element comprises a stop ledge 54, 64 disposed near to a tip 52t, 62t of the first arm 52, 62 on an inner surface thereof. When the first and second arms 52, 53, 62, 63 are moved toward the trigger mechanism 14, 24, an inner surface of the tip 52t, 62t of the first arm 52, 62 abuts a central portion of the trigger mechanism 14, 24 and the stop ledge 54, 64 abuts an end of the trigger mechanism 14, 24, together with the second arm 53, 63, the vice-like gripping force is formed squeezing the trigger mechanism 14, 24 for removal of the fibre optic connector 10, 20 from the adapters, couplers, modules and ports of fibre optic systems.

In some embodiments, the at least a gripping element comprises a grip ledge 59 disposed near to a center of the first arm 52 on an inner surface thereof, and the fibre optic connector 10 further has a boot 13 on an end thereof. When the first and second arms 52, 53 are moved toward the trigger mechanism 14, an inner surface of the tip 52t of the first arm 52 abuts a central portion of the trigger mechanism 14 and the grip ledge 59 abuts the boot 13, together with the second arm 53, the vice-like gripping force is formed squeezing the trigger mechanism 14 for removal of the fibre optic connector 10 from the adapters, couplers, modules and ports of fibre optic systems.

In certain embodiments, the shape of the stop ledge 54, 64 and grip ledge 59 are triangular shaped; however, those of ordinary skill in the relevant art may readily appreciate, that other designs may be implemented for abutting an end of the trigger mechanism 14, 24 and abutting the boot 13, and the embodiments are not limited.

In some embodiments, the at least a gripping element comprises a stop groove 55 disposed near to a tip 53t of the second arm 53 on an inner surface thereof, and the fibre optic connector 10 further has an outer protrusion 15 near to an end thereof. When the first and second arms 52, 53 are moved toward the trigger mechanism 14, an inner surface of the tip 52t of the first arm 52 abuts a central portion of the trigger mechanism 14 and the stop groove 55 of the second arm 53 abuts the outer protrusion 15, forming the vice-like gripping force squeezing the trigger mechanism 14 for removal of the fibre optic connector 10 from the adapters, couplers, modules and ports of fibre optic systems. In certain embodiments, the stop groove 55 of the second arm 53 corresponds with the outer protrusion 15 of the fibre optic connector 10.

In some embodiments, the at least a gripping element comprises a plurality of ridges 58 disposed surrounding a tip 52t of the first arm 52 on a side and inner surface thereof. When the first and second arms 52, 53 are moved toward the trigger mechanism 14, the plurality of ridges 58 disposed on the inner surface of the tip 52t of the first arm 52 abuts a central portion of the trigger mechanism 14, together with the second arm 53, the vice-like gripping force is formed squeezing the trigger mechanism 14 for removal of the fibre optic connector 10 from the adapters, couplers, modules and ports of fibre optic systems.

In some embodiments, the fibre optic connector insertion and removal tool 30, 70 further comprises a positioning label 57, 66 disposed on an outer surface of the first arm 52, 72 for easy viewing and positioning of the fibre optic connector insertion and removal tool 30, 70 with the different fibre optic connectors 10, 20.

In the embodiments, fibre optic connector insertion and removal tools 30, 70 comprising a portable light 31, light conduit 40, first gripping apparatus 50, and second gripping apparatus 60 are provided. The first gripping apparatus 50, 60 has a U-shaped fork comprising first and second arms 52, 53, 62, 63 and at least a gripping element. Tip portions 52p, 53p, 62p, 63p of the first and second arms 52, 53, 62, 63 and the at least a gripping element form a vice-like grip for insertion of a fibre optic connector 10, 20 having a trigger mechanism 14, 24 and at least a connector 12, 22. When the first and second arms 52, 53, 62, 63 move toward the trigger mechanism 14, 24, a vice-like gripping force is formed between tip portions 52p, 53p, 62p, 63p of the first and second arms 52, 53, 62, 63 and at least a gripping element, squeezing the trigger mechanism 14, 24 for removal of the fibre optic connector 10, 20. The light conduit 40 transmits or guides light to the tip portions 52p, 53p, 62p, 63p of the first and second arms 52, 53, 62, 63. The first gripping apparatus 50 is removable and replaceable with the second gripping apparatus 60.

With new data centers being built and existing data centers being upgraded the problem of poor fiber connection alignment and/or crossing of fiber optic cables during installation have increased. Often, there are multiple adapters and optic fiber segments connected in a data center, with denser network configurations, changing not just once, but, several times during deployment. A wrong connection, results in non-precise alignment of the optical fiber cores, signal degradation, damaged equipment or devices, or signals not being transmitted. Changing of the multiple adapters and optic fiber segments, wherein any manual adjustment to connectors is required, increases the risk of non-precise alignment of the optical fiber cores of the adapters and optic fiber segments and damage to neighboring adapters and optic fiber segments. Additionally, changing of the multiple adapters and optic fiber segments, require installers to carefully inspect adapters, often, in less than clearly visible conditions, to assure desired polarity connection, which further increases installation time and/or additional tools for clear visibility. If additional tools are required by installers, often, the tools are specific to a specific type of fibre optic connector, thus, requiring the installer to carry more than one type of tool for each specific type of fibre optic connector.

The embodiments of the fibre optic connector insertion and removal tool 30, 70 allow for technicians to efficiently and conveniently hold, grip, and manipulate fibre optic connectors in dense hard to reach and hard to see places. The tips 52t, 53t, 62t, 63t of the first and second arms 52, 53, 62, 63 of the gripping apparatus 50, 60 and at least a gripping element of the embodiments form a vice-like grip on fibre optic connectors to efficiently and conveniently hold fibre optic connectors for precise insertion into adapters, couplers, modules and ports of fibre optic systems. Thus, the risk of non-precise alignment of the optical fiber cores of adapters and optic fiber segments and damage to neighboring adapters and optic fiber segments are decreased. Additionally, the vice-like gripping force formed between the tip portions 52p, 53p, 62p, 63p of the first and second arms 52, 53, 62, 63 and at least a gripping element when the gripping apparatus 50, 60 moves toward the fibre optic connectors, squeezes the trigger mechanism 14, 24 for efficient and convenient unhinging and removal of the fibre optic connector from the adapters, couplers, modules and ports of fibre optic systems. The stop ledges 54, 64, grip ledge 59, stop groove 55, and plurality of ridges 58, individually or in any combination enhance the vice-like grip and vice-like gripping force of the gripping apparatus 50, 60. The ease of use, removability and replaceability of the first gripping apparatus 50 with the second gripping apparatus 60 via the first stem 56, 65 being inserted into the receiving hole 43 for attachment, allows technicians to quickly and efficiently change the gripping apparatus 50, 60 to more efficiently hold, grip, and manipulate different types of fibre optic connectors. The portable light 31 and light conduit 40 transmits or guides light to the tip portions 52p, 53p, 62p, 63p of the first and second arms 52, 53, 62, 63, allowing installers to efficiently, conveniently and carefully inspect adapters in a clear and visible condition, decreasing installation time without additional tools.

The presently disclosed inventive concepts are not intended to be limited to the embodiments shown herein, but are to be accorded their full scope consistent with the principles underlying the disclosed concepts herein. Directions and references to an element, such as “up,” “down,”, “upper,” “lower,” “horizontal,” “vertical,” “left,” “right,” and the like, do not imply absolute relationships, positions, and/or orientations. Terms of an element, such as “first” and “second” are not literal, but, distinguishing terms. As used herein, terms “comprises” or “comprising” encompass the notions of “including” and “having” and specify the presence of elements, operations, and/or groups or combinations thereof and do not imply preclusion of the presence or addition of one or more other elements, operations and/or groups or combinations thereof. Sequence of operations do not imply absoluteness unless specifically so stated. Reference to an element in the singular, such as by use of the article “a” or “an”, is not intended to mean “one and only one” unless specifically so stated, but rather “one or more”. As used herein, “and/or” means “and” or “or”, as well as “and” and “or.” As used herein, ranges and subranges mean all ranges including whole and/or fractional values therein and language which defines or modifies ranges and subranges, such as “at least,” “greater than,” “less than,” “no more than,” and the like, mean subranges and/or an upper or lower limit. All structural and functional equivalents to the elements of the various embodiments described throughout the disclosure that are known or later come to be known to those having ordinary skill in the relevant art are intended to be encompassed by the features described and claimed herein. Moreover, nothing disclosed herein is intended to be dedicated to the public regardless of whether such disclosure may ultimately explicitly be recited in the claims. No element or concept disclosed herein or hereafter presented shall be construed under the provisions of 35 USC 112(f) unless the element or concept is expressly recited using the phrase “means for” or “step for”.

In view of the many possible embodiments to which the disclosed principles can be applied, we reserve the right to claim any and all combinations of features and acts described herein, including the right to claim all that comes within the scope and spirit of the foregoing description, as well as the combinations recited, literally and equivalently, in the following claims and any claims presented anytime throughout prosecution of this application or any application claiming benefit of or priority from this application.

What is claimed is:

1. A fibre optic connector insertion and removal tool, comprising:
a first gripping apparatus, configured to grip fibre optic connectors, having a U-shaped fork comprising a first closed end, a first arm connected to one end of the first closed end, a second arm connected to an other end of the first closed end, opposite the first arm, and at least a gripping element disposed near to a tip or tips of the first or second arm or both, opposite the first closed end,
wherein tip portions of the first and second arms and the at least a gripping element form a vice-like grip, whereby the first and second arms are configured to hold a fibre optic connector therein for insertion into adapters, couplers, modules and ports of fibre optic systems, the fibre optic connector has a trigger mechanism and at least a connector, and when the first and second arms are moved toward the trigger mechanism, a vice-like gripping force is formed between the tip portions of the first and second arms and at least a gripping element, squeezing the trigger mechanism for removal of the fibre optic connector from the adapters, couplers, modules and ports of fibre optic systems.

2. The fibre optic connector insertion and removal tool of claim 1, further comprising:
a portable light, configured to emit light, having a handle and a head, wherein the head comprises a pill end and an emissions end, and the pill end is connected to the handle; and
a light conduit, configured to transmit or guide light, having a distal end and a proximal end, wherein the distal end is attached to the emissions end;
wherein the first closed end is attached to the proximal end, and the light conduit transmits or guides light to the tip portions of the first and second arm.

3. The fibre optic connector insertion and removal tool of claim 2, wherein the portable light further comprises a light emitting diode (LED) unit disposed in the pill end, configured to switch the portable light on and off, and a material of the light conduit comprises optical grade Polymethyl Methacrylate (PMMA).

4. The fibre optic connector insertion and removal tool of claim 2, wherein the first gripping apparatus further comprises a first stem protruding from the first closed end, the light conduit further comprises a receiving hole at the proximal end, and the fibre optic connector insertion and removal tool further comprises a second gripping apparatus having a second stem protruding from a second closed end, the second gripping apparatus different from the first gripping apparatus, whereby the first stem is inserted into the receiving hole for attachment of the first gripping apparatus to the light conduit, and the first gripping apparatus is removable from the receiving hole and replaceable with the second gripping apparatus.

5. The fibre optic connector insertion and removal tool of claim 1, wherein the at least a gripping element comprises a stop ledge disposed near to a tip of the first arm on an inner surface thereof, whereby when the first and second arms are moved toward the trigger mechanism, an inner surface of the tip of the first arm abuts a central portion of the trigger mechanism and the stop ledge abuts an end of the trigger mechanism, together with the second arm, forming the vice-like gripping force squeezing the trigger mechanism for removal of the fibre optic connector from the adapters, couplers, modules and ports of fibre optic systems.

6. The fibre optic connector insertion and removal tool of claim 1, wherein the at least a gripping element comprises a grip ledge disposed near to a center of the first arm on an inner surface thereof, and the fibre optic connector further has a boot on an end thereof, whereby when the first and second arms are moved toward the trigger mechanism, an inner surface of the tip of the first arm abuts a central portion of the trigger mechanism and the grip ledge abuts the boot, together with the second arm, forming the vice-like gripping force squeezing the trigger mechanism for removal of the fibre optic connector from the adapters, couplers, modules and ports of fibre optic systems.

7. The fibre optic connector insertion and removal tool of claim 1, wherein the at least a gripping element comprises a stop groove disposed near to a tip of the second arm on an inner surface thereof, and the fibre optic connector further has an outer protrusion near to an end thereof, whereby when the first and second arms are moved toward the trigger mechanism, an inner surface of the tip of the first arm abuts a central portion of the trigger mechanism and the stop groove of the second arm abuts the outer protrusion, forming the vice-like gripping force squeezing the trigger mechanism for removal of the fibre optic connector from the adapters, couplers, modules and ports of fibre optic systems.

8. The fibre optic connector insertion and removal tool of claim 1, wherein the at least a gripping element comprises a plurality of ridges disposed surrounding a tip of the first arm on a side and inner surface thereof, whereby when the first and second arms are moved toward the trigger mechanism, the plurality of ridges disposed on the inner surface of the tip of the first arm abuts a central portion of the trigger mechanism, together with the second arm, forming the vice-like gripping force squeezing the trigger mechanism for removal of the fibre optic connector from the adapters, couplers, modules and ports of fibre optic systems.

9. The fibre optic connector insertion and removal tool of claim 1, wherein the fibre optic connector comprises an LC fibre optic connector or an LC uniboot fibre optic connector.

10. The fibre optic connector insertion and removal tool of claim 1, wherein the fibre optic connector comprises a duplex fibre optic connector.

11. A fibre optic connector insertion and removal tool, comprising:
a portable light, configured to emit light, having a handle and a head, wherein the head comprises a pill end and an emissions end, and the pill end is connected to the handle;
a light conduit, configured to transmit or guide light, having a distal end and a proximal end, wherein the distal end is attached to the emissions end; and
a first gripping apparatus, configured to grip fibre optic connectors, having a U-shaped fork comprising a first closed end, a first arm connected to one end of the first closed end, a second arm connected to an other end of the first closed end, opposite the first arm, and at least a gripping element disposed near to a tip or tips of the first or second arm or both, opposite the first closed end, wherein the first closed end is attached to the proximal end,
wherein the light conduit transmits or guides light to the tip portions of the first and second arm, and tip portions of the first and second arms and the at least a gripping element form a vice-like grip, whereby the first and second arms are configured to hold a fibre optic connector therein for insertion into adapters, couplers, modules and ports of fibre optic systems, the fibre optic connector having a trigger mechanism and at least a connector, and when the first and second arms are moved toward the trigger mechanism, a vice-like gripping force is formed between the tip portions of the first and second arms and at least a gripping element, squeezing the trigger mechanism for removal of the fibre optic connector from the adapters, couplers, modules and ports of fibre optic systems.

12. The fibre optic connector insertion and removal tool of claim 11, wherein the portable light further comprises a light emitting diode (LED) unit disposed in the pill end, configured to switch the portable light on and off.

13. The fibre optic connector insertion and removal tool of claim 11, wherein a material of the light conduit comprises optical grade Polymethyl Methacrylate (PMMA).

14. The fibre optic connector insertion and removal tool of claim 11, wherein the first gripping apparatus further comprises a first stem protruding from the first closed end, the light conduit further comprises a receiving hole at the proximal end, and the fibre optic connector insertion and removal tool further comprises a second gripping apparatus having a second stem protruding from a second closed end, the second gripping apparatus different from the first gripping apparatus, whereby the first stem is inserted into the receiving hole for attachment of the first gripping apparatus to the light conduit, and the first gripping apparatus is removable from the receiving hole and replaceable with the second gripping apparatus.

15. The fibre optic connector insertion and removal tool of claim 11, wherein the at least a gripping element comprises a stop ledge disposed near to a tip of the first arm on an inner surface thereof, whereby when the first and second arms are moved toward the trigger mechanism, an inner surface of the tip of the first arm abuts a central portion of the trigger mechanism and the stop ledge abuts an end of the trigger mechanism, together with the second arm, forming the vice-like gripping force squeezing the trigger mechanism for removal of the fibre optic connector from the adapters, couplers, modules and ports of fibre optic systems.

16. The fibre optic connector insertion and removal tool of claim 11, wherein the at least a gripping element comprises a grip ledge disposed near to a center of the first arm on an inner surface thereof, and the fibre optic connector further has a boot on an end thereof, whereby when the first and second arms are moved toward the trigger mechanism, an inner surface of the tip of the first arm abuts a central portion of the trigger mechanism and the grip ledge abuts the boot, together with the second arm, forming the vice-like gripping force squeezing the trigger mechanism for removal of the fibre optic connector from the adapters, couplers, modules and ports of fibre optic systems.

17. The fibre optic connector insertion and removal tool of claim 11, wherein the at least a gripping element comprises a stop groove disposed near to a tip of the second arm on an inner surface thereof, and the fibre optic connector further has an outer protrusion near to an end thereof, whereby when the first and second arms are moved toward the trigger mechanism, an inner surface of the tip of the first arm abuts a central portion of the trigger mechanism and the stop groove of the second arm abuts the outer protrusion, forming the vice-like gripping force squeezing the trigger mechanism for removal of the fibre optic connector from the adapters, couplers, modules and ports of fibre optic systems.

18. The fibre optic connector insertion and removal tool of claim 11, wherein the at least a gripping element comprises a plurality of ridges disposed surrounding a tip of the first arm on a side and inner surface thereof, whereby when the first and second arms are moved toward the trigger mechanism, the plurality of ridges disposed on the inner surface of the tip of the first arm abuts a central portion of the trigger mechanism, together with the second arm, forming the vice-like gripping force squeezing the trigger mechanism for removal of the fibre optic connector from the adapters, couplers, modules and ports of fibre optic systems.

19. The fibre optic connector insertion and removal tool of claim 11, wherein the fibre optic connector comprises an LC fibre optic connector or an LC uniboot fibre optic connector.

20. The fibre optic connector insertion and removal tool of claim 11, wherein the fibre optic connector comprises a duplex fibre optic connector.
